(19) United States
(12) Patent Application Publication
(10) Pub. No.: US 2014/0133870 A1
(43) Pub. Date: May 15, 2014

(54) OPTICAL TRANSMITTER FOR GENERATING MULTI-LEVEL OPTICAL SIGNAL AND METHOD THEREFOR

(71) Applicant: Electronics and Telecommunications Research Institute, Daejeon-si (KR)

(72) Inventors: Joon Ki LEE, Daejeon-si (KR); Joon Young HUH, Daejeon-si (KR); Sae-Kyoung KANG, Daejeon-si (KR)

(73) Assignee: Electronics and Telecommunications Research Institute, Daejeon-si (KR)

(21) Appl. No.: 14/014,348

(22) Filed: Aug. 29, 2013

(30) Foreign Application Priority Data
Nov. 13, 2012 (KR) 10-2012-0128350

(51) Int. Cl. H04B 10/54

(52) U.S. Cl. CPC H04B 10/541
USPC 398/186

(57) ABSTRACT

An optical transmitter for generating a multi-level optical signal and a method therefore are provided. The optical transmitter includes an optical power splitter configured to split one optical signal into N paths, N optical intensity modulators configured to modulate the split optical signals into binary optical signals, and an optical power combiner configured to combine the intensity-modulated optical signals to generate a multi-level optical signal having 2^{N} levels.

### CROSS-REFERENCE TO RELATED APPLICATION

This application claims the benefit under 35 U.S.C. §119(a) of a Korean Patent Application No. 10-2012-0128350, filed on Nov. 13, 2012, in the Korean Intellectual Property Office, the entire disclosure of which is incorporated herein by reference for all purposes.

### BACKGROUND

1. Field

The following description relates to an optical transmitter, and more particularly, to an apparatus for converting an electrical signal into an optical signal.

2. Description of the Related Art

Due to the proliferation of smart phones and the appearance of new networking services such as a cloud service, etc., there is a growing demand for high-speed high-capacity networks based on optical communication. As a method of increasing transmission capacity in a backbone network for long-distance transmission, there is a wavelength division multiplexing (WDM) method of multiplexing a number of optical signals into a single optical fiber by using different wavelengths. Further, a method of increasing transmission capacity per wavelength is being studied together with the wavelength division multiplexing method. As the method of increasing transmission capacity per wavelength, there are technologies of increasing transmission efficiency using various modulation methods of mixing a phase modulation method and a multi-level modulation method instead of a method of transmitting a binary-level signal.

In 40 G (Gigabit) and 100 G (Gigabit) Ethernet standards in the Ethernet field, which started as a communication protocol between computers located in the same vicinity, a method of parallel-transmitting through a ribbon optical fiber has been standardized. In the 40 G Ethernet, 10 G×4 channel coarse wavelength division multiplexing (CWDM) method for 10 km transmission via a single mode optical fiber is adopted as a standard. In the 100 G Ethernet, 25 G×4 channel local area network-wavelength division multiplexing (LAN-WDM) method for 10 km and 40 km transmission via a single mode optical fiber is adopted as a standard. A technology adding a multi-level optical intensity modulation technology into the wavelength division multiplexing method is to be used as a next generation of Ethernet transmission technology, and is forecast to increase transmission capacity.

### SUMMARY

The following description relates to an optical transmitter for generating a multi-level optical signal using an optical device without electrically generating multiple levels when generating the multi-level optical signal.

In one general aspect, there is provided an optical transmitter, including: an optical power splitter configured to split one optical signal into N paths; N optical intensity modulators configured to modulate the split optical signals into binary optical signals; and an optical power combiner configured to combine the intensity-modulated optical signals to generate a multi-level optical signal having 2^{N} levels.

Each of the N optical intensity modulators may receive a binary electrical signal and modulate the split optical signals output from the optical power splitter into binary optical signals using the binary electrical signals.

The optical intensity modulator may be a Mach-Zehnder optical intensity modulator or an electro-absorption modulator.

The optical power splitter and the optical power combiner may have a splitting ratio and a combining ratio, respectively, so that the intensity-modulated optical signals are output in a ratio of 2^{N-1}: . . . :2¹:1 at an output port of the optical power combiner. In this case, the optical power splitter, when splitting the optical signal, may split the optical power in the ratio of 2^{N-1}: . . . :2¹:1 for the split optical signals, and the optical power combiner, when combining the optical signals, may combine the optical power in a ratio of 1: . . . :1:1 for the intensity-modulated optical signals in respective paths. Also, the optical power splitter, when splitting the optical signal, may split the optical power in the ratio of 1: . . . :1:1 for the split optical signals, and the optical power combiner, when combining the optical signals, may combine the optical power in a ratio of 2^{N-1}: . . . :2¹:1 for the intensity-modulated optical signals in respective paths.

The splitting ratio of the optical power splitter and the combining ratio of the optical power combiner may both be 1: . . . :1:1, in which case the optical transmitter may further include an optical attenuator located before or after each of the N power intensity modulators and configured to attenuate optical power along a corresponding path. Further, the optical transmitter may further include a monitoring photodiode configured to adjust the intensity of each of the optical signals combined by the optical power combiner.

Each of the optical intensity modulators may receive a binary electrical signal whose amplitude is modulated, and modulate the split optical signals output from the optical power splitter into a binary optical signal using the amplitude-modulated binary electrical signal. In this case, the N optical intensity modulators may receive the amplitude-modulated binary electrical signals in respective ratios of

$$1 \text{:} \frac{1}{2} \text{:} … \text{:} \frac{1}{{2}^{N - 1}}$$

In another aspect, there is provided a method of generating a multi-level optical signal of an optical transmitter, including: splitting one optical signal into N paths using an optical power splitter; modulating the split optical signals output by the optical power splitter to binary optical signals using N optical intensity modulators; and combining the intensity-modulated optical signals output by the N optical intensity modulators, and generating a multi-level optical signal having 2^{N} levels using an optical power combiner.

Other features and aspects will be apparent from the following detailed description, the drawings, and the claims.

### BRIEF DESCRIPTION OF THE DRAWINGS

FIGS. 1 and 2 are diagrams illustrating a construction of an optical transmitter according a first embodiment of the inventive concept.

FIG. 3 is a reference diagram illustrating an optical transmitter generating an 8-level optical signal according to a first embodiment of the inventive concept.

FIG. 4 is a reference diagram illustrating an optical transmitter generating a 4-level optical signal according to a first embodiment of the inventive concept.

FIG. 5 is a diagram illustrating a construction of an optical transmitter according to a second embodiment of the inventive concept.

FIG. 6 is a diagram illustrating a construction of an optical transmitter that can generate an optimal multi-level optical signal by adding a plurality of monitoring photodiodes and applying a variable optical attenuator to the construction of FIG. 5 according to a second embodiment of the inventive concept.

FIG. 7 is a diagram illustrating a construction of an optical transmitter according a third embodiment of the inventive concept.

FIG. 8 is a flowchart illustrating a method of generating a multi-level optical signal according to an embodiment of the inventive concept.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

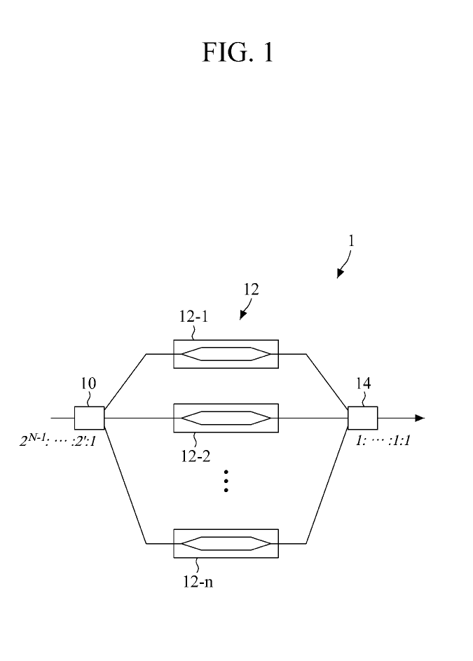

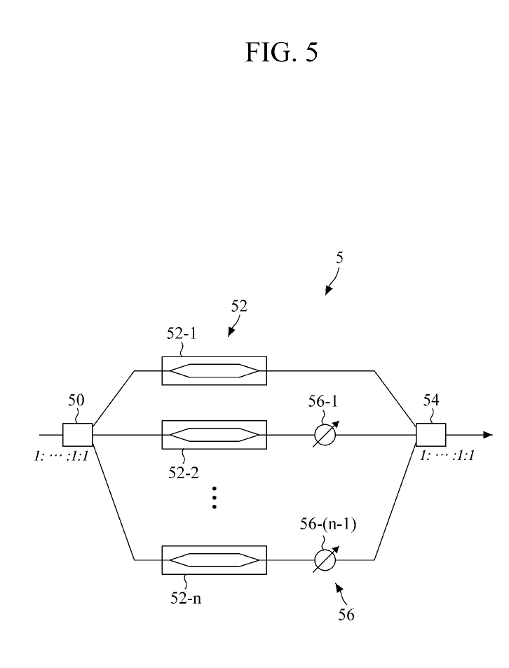

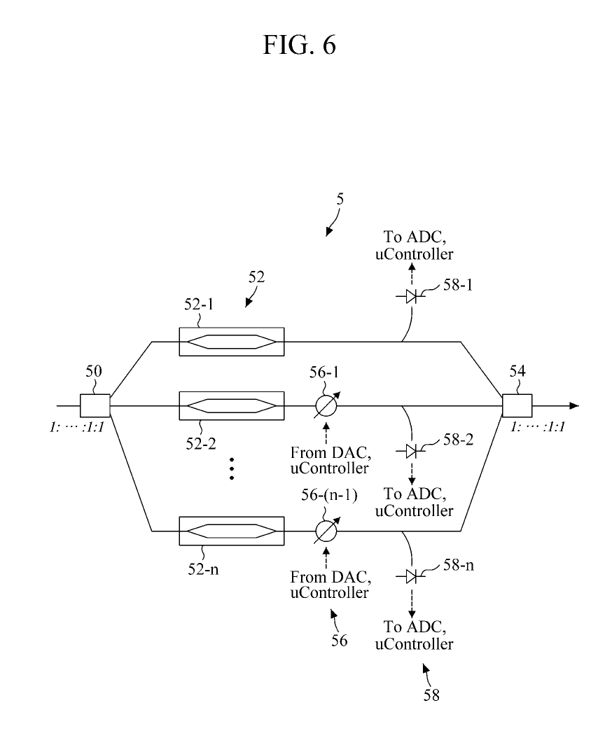

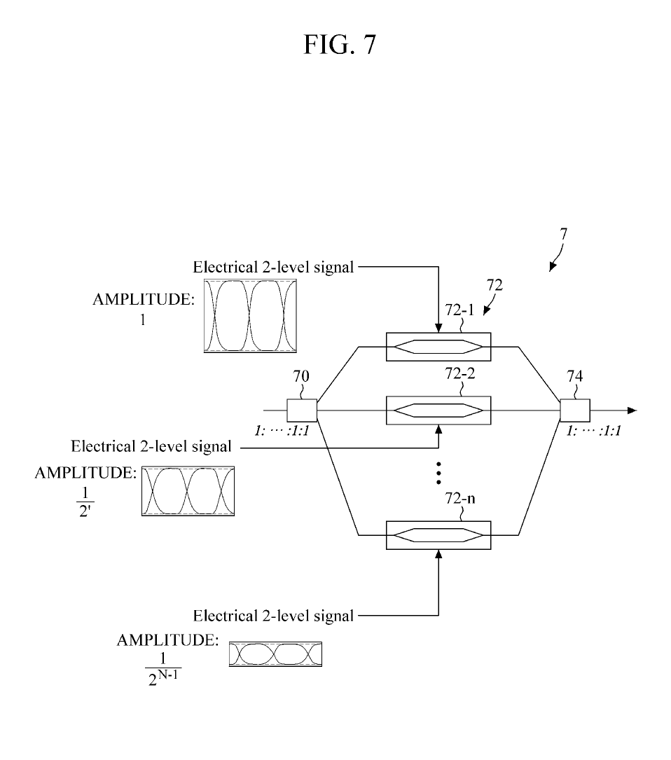

An optical transmitter of the inventive concept is technology for generating a multi-level optical signal, not electrically, but using an optical device. In order to generate the multi-level optical signal, the inventive concept suggests a first method of using an optical power splitter and an optical power combiner, a second method of using an optical attenuator, and a third method of adjusting an amplitude of an electrical signal. The first method will be described below with reference to FIGS. 1 to 4, the second method with reference to FIGS. 5 and 6, and the third method with reference to FIG. 7.

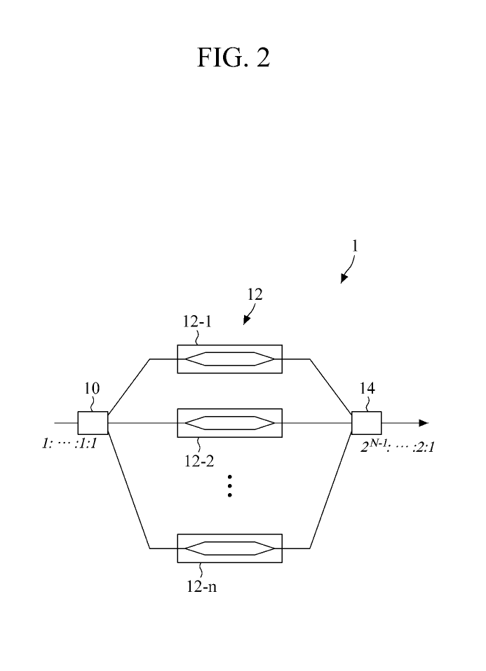

FIGS. 1 and 2 are diagrams illustrating a construction of an optical transmitter according a first embodiment of the inventive concept.

Referring to FIGS. 1 and 2, the optical transmitter 1, in order to generate a multi-level optical signal having 2^{N} levels, may include a single optical power splitter 10, N optical intensity modulators 12, and a single optical power combiner 14.

The optical power splitter 10 may split a single optical signal into N paths, each of the N optical intensity modulators 12 may modulate the split optical signal to a binary optical signal, and the optical power combiner 14 may combine the N intensity-modulated optical signals generated from the N optical intensity modulators 12 and generate the multi-level optical signal having 2^{N} levels.

The optical intensity modulators 12 may be a Mach-Zehnder optical intensity modulator, an electro-absorption modulator (EAM), etc. The optical power splitter 10 may be composed of a single input port and N output ports, and the optical power combiner 14 may be composed of N input ports and a single output port. A splitting ratio of the optical power splitter 10 and a combining ratio of the optical power combiner 14 may be determined as the splitting ratio and the combining ratio, so that the intensity-modulated optical signals in respective paths are output in a ratio of 2^{N-1}: . . . :2¹:1 at an output port of the optical power combiner 14.

Though the splitting ratio and the combining ratio may vary from case to case, in the simplest example, shown in FIG. 1, the optical power output from the optical power splitter 10 may be split in a ratio of 2^{N-1}: . . . :2¹:1, and the optical power input to respective ports of the optical power combiner 14 may be set to a uniform ratio of 1: . . . :1:1. For another example, as shown in FIG. 2, there may be a case in which the optical power output from the optical power splitter 10 is set to the uniform ratio of 1: . . . :1:1, and the optical power input to respective ports of the optical power combiner 14 is set to a ratio of 2^{N-1}: . . . :2¹:1.

In real implementation, since the splitting and combining ratios of the optical power may be not exactly adjusted, these ratios may have approximate values. In order to make a plurality of output ports for the optical power splitter 10, and a plurality of input ports in the optical power combiner 14, a plurality of optical power splitters 10 and a plurality of optical power combiners 14 may be connected and used.

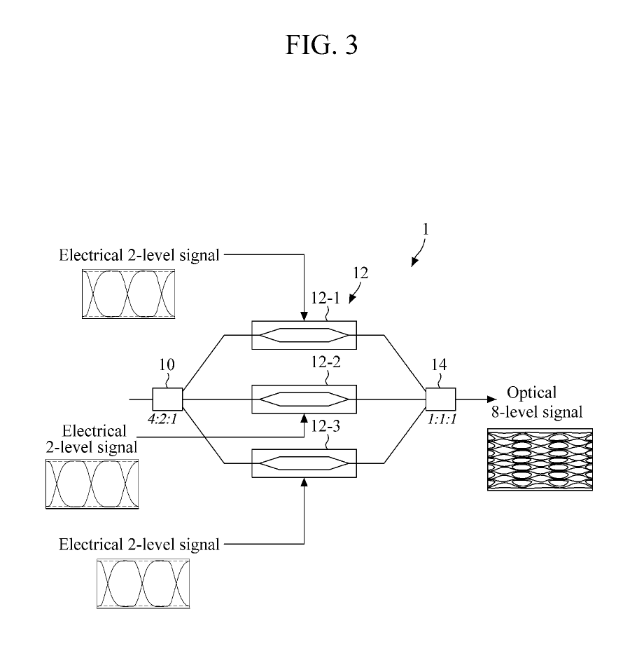

FIG. 3 is a reference diagram illustrating an optical transmitter generating an 8-level optical signal according to a first embodiment of the inventive concept.

Referring to FIG. 3, the optical transmitter 1 may include three optical intensity modulators 12-1, 12-2 and 12-3, an optical power splitter 10 splitting optical power in a ratio of 4:2:1, and an optical power combiner 14 combining the optical power in the uniform ratio of 1:1:1.

Accordingly, a first optical intensity modulator 12-1 may receive an optical signal (7 divided by 4) of the highest optical power, and a third optical intensity modulator 12-3 may receive an optical signal (7 divided by 1) of the lowest optical power. Each of the optical intensity modulators 12-1, 12-2 and 12-3 may receive a DC bias voltage, and an electrical 2-level signal for on-off modulation. A binary optical signal output from each of the optical intensity modulators 12-1, 12-2 and 12-3 may be combined into one in the optical power combiner 14, and an optical signal having 8 levels may be output at an output port of the optical power combiner 14 since the optical power is set in a ratio of 4:2:1.

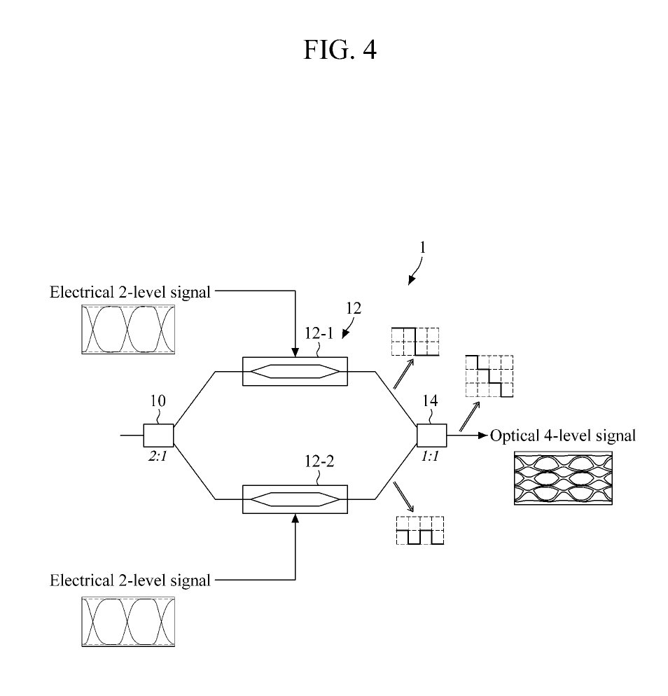

FIG. 4 is a reference diagram illustrating an optical transmitter generating a 4-level optical signal according to a first embodiment of the inventive concept.

Suppose that a binary electrical signal with a pattern of 1100 is input to the first optical intensity modulator 12-1 and a binary electrical signal with a pattern of 1010 is input to the second optical intensity modulator 12-2. Due to a 2:1 splitting ratio of the optical power splitter 10, since the optical intensity input to the first optical intensity modulator 12-1 is twice as high as the optical intensity input to the second optical intensity modulator 12-2, as shown in FIG. 4, optically, an effect of adding the patterns of 2200 and 1010 may occur. Finally, a pattern of 3210 may be output from the optical power combiner 14.

FIG. 5 is a diagram illustrating a construction of an optical transmitter according to a second embodiment of the inventive concept.

Referring to FIG. 5, the optical transmitter 5, in order to generate a multi-level optical signal having 2^{N} levels, may include a single optical power splitter 50, N optical intensity modulators 52, a single optical power combiner 54, and N−1 optical attenuators 56.

The optical intensity modulator 52 may be a Mach-Zehnder optical intensity modulator or an electro-absorption modulator, etc. The optical power splitter 50 may be composed of a single input port and N output ports, and a ratio of an optical power output to each output port may be split in the uniform ratio of 1: . . . :1:1. The optical power combiner 54 may be composed of N input ports and a single output port, and the optical power input to respective ports may be combined in a uniform ratio.

According to an embodiment of the inventive concept, the first optical attenuator 56-1 may attenuate the optical intensity by 3 dB, the second optical attenuator 56-2 may attenuate the optical intensity by 6 dB, and the (N−1) optical attenuator 56-(N−1) may attenuate the optical intensity by 3N dB. The optical attenuator 56 may be located behind or in front of the optical intensity modulator 52 in FIG. 5, and it may perform the same function in both cases. In real implementation, since an attenuation of the optical attenuator 56 may not be exactly adjusted, the attenuation of the optical attenuator 56 may have an approximate value. In order to make a plurality of output ports in the optical power splitter 50, and a plurality of input ports in the optical power combiner 54, a plurality of optical power splitters 50 and a plurality of optical power combiners 54 may be connected and used.

FIG. 6 is a diagram illustrating a construction of an optical transmitter that can generate an optimal multi-level optical signal by adding a plurality of monitoring photodiodes and applying a variable optical attenuator to the construction of FIG. 5 according to a second embodiment of the inventive concept.

Referring to FIG. 6, a microcontroller (uController) of the optical transmitter 5 may adjust each optical signal intensity input to the optical power combiner 54 through a monitoring photodiode (PD) 58. Here, the optical attenuator 56 may be located in front of the optical intensity modulator 52.

FIG. 7 is a diagram illustrating a construction of an optical transmitter according a third embodiment of the inventive concept.

Referring FIG. 7, an optical transmitter 7 may generate a multi-level optical signal having 2^{N} levels by modulating the amplitude of an electrical signal. The optical intensity modulator 72 may be a Mach-Zehnder optical intensity modulator or an electro-absorption modulator, etc. The optical power splitter 70 may be composed of a single input port and N output ports, and may split an optical power output to each output port in the uniform ratio of 1: . . . :1:1. The optical power combiner 74 may be composed of N input ports and a single output port, and may combine the optical power input to respective ports in a uniform ratio.

According to an embodiment of the inventive concept, if the amplitude of a binary electrical signal applied to the first optical intensity modulator 72-1 is 1, a binary electrical signal having an amplitude of ½ may be applied to the second optical intensity modulator 72-2, and a binary electrical signal having an amplitude of

$$\frac{1}{( {2}^{N - 1} )}$$

may be applied to the N-th optical intensity modulator 72-N. At this time, a DC bias voltage may be input such that optical power is sequentially reduced by a factor of ½ at an output port of the optical intensity modulators 72-1, 72-2, . . ., 72-N. In order to make a plurality of output ports in the optical power splitter 70, and a plurality of input ports in the optical power combiner 74, a plurality of the optical power splitters 50 and a plurality of the optical power combiners 54 may be connected and used.

While three separate methods of generating a multi-level signal have been described above with reference to FIGS. 1 to 7, the multi-level optical signal may be generated by suitably combining two or three different methods.

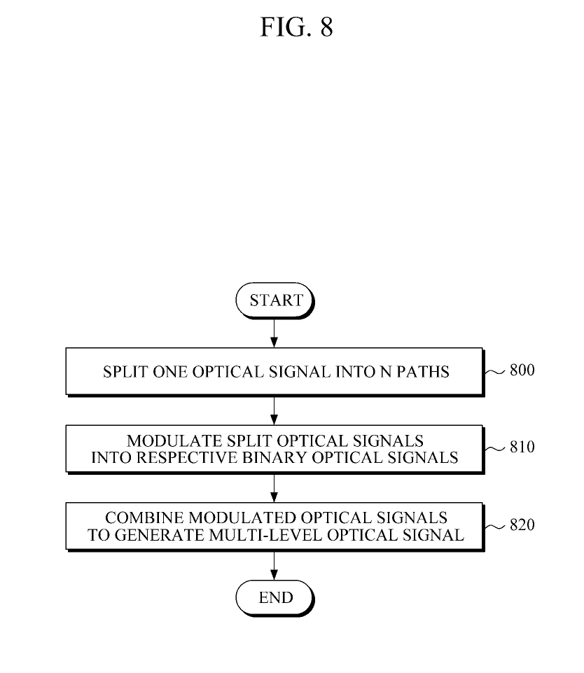

FIG. 8 is a flowchart illustrating a method of generating a multi-level optical signal according to an embodiment of the inventive concept.

Referring to FIG. 8, the optical transmitter may use an optical power splitter and split one optical signal into N paths in 800. Subsequently, each of the split optical signals output by the optical power splitter may be modulated into binary optical signal using N optical intensity modulators in 810. Each of the intensity-modulated optical signals output from the N optical intensity modulators may be combined to generate a multi-level optical signal having 2^{N} levels, using the optical power combiner in 820.

In the operation 810, the optical intensity modulator may receive a binary electrical signal and modulate the split optical signals output from the optical power splitter into binary optical signals using the binary electrical signals. The optical intensity modulator may be a Mach-Zehnder optical intensity modulator or an electro-absorption modulator, etc.

Both a splitting ratio of the optical power splitter and a combining ratio of the optical power combiner may be 1: . . . :1:1. In this case, an optical power in a corresponding path may be attenuated by the optical attenuator which is located in front of or behind the optical intensity modulator. Moreover, the intensity of each of the optical signals combined by the optical power combiner may be adjusted by a monitoring photodiode.

In the operation 810, the optical intensity modulator may receive the binary electrical signal whose amplitude is modulated, and modulate the split optical signals output from the optical power splitter into a binary optical signal using the amplitude-modulated binary electrical signal.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier wave such as those used in Internet transmissions. In addition, the computer-readable recording medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components of a described system, architecture, device, or circuit are combined in a different manner and/or replaced or supplemented by other components or their equivalents. Accordingly, other implementations are within the scope of the following claims.

What is claimed is:

1. An optical transmitter, comprising:
an optical power splitter configured to split one optical signal into N paths;
N optical intensity modulators configured to modulate the split optical signals into binary optical signals; and
an optical power combiner configured to combine the intensity-modulated optical signals to generate a multi-level optical signal having 2^{N} levels.

2. The optical transmitter according to claim 1, wherein the optical power splitter and the optical power combiner have a splitting ratio and a combining ratio, respectively, so that the intensity-modulated optical signals are output in a ratio of 2^{N-1}: . . . : 2¹:1 at an output port of the optical power combiner.

3. The optical transmitter according to claim 2, wherein the optical power splitter splits the optical power in the ratio of 2^{N-1}: . . . :2¹:1 for the split signals when splitting the optical signal, and the optical power combiner combines the optical power in a ratio of 1: . . . :1:1 for the intensity-modulated optical signals in respective paths when combining the optical signals.

4. The optical transmitter according to claim 2, wherein the optical power splitter splits the optical power in a ratio of 1: . . . :1:1 for the split signals when splitting the optical signal, and the optical power combiner combines the optical power in the ratio of 2^{N-1}: . . . :2¹:1 for the intensity-modulated optical signals in respective paths when combining the optical signals.

5. The optical transmitter according to claim 1, wherein a splitting ratio of the optical power splitter and a combining ratio of the optical power combiner are both 1: . . . :1:1, and the optical transmitter further comprises an optical attenuator located before or after the power intensity modulator, and configured to attenuate optical power along a corresponding path.

6. The optical transmitter according to claim 5, further comprising a monitoring photodiode configured to adjust the intensity of each of optical signals combined by the optical power combiner.

7. The optical transmitter according to claim 1, wherein each of the N optical intensity modulators receives a binary electrical signal and modulates a corresponding split optical signals output from the optical power splitter into binary optical signals using the binary electrical signals.

8. The optical transmitter according to claim 1, wherein the optical intensity modulator is a Mach-Zehnder optical intensity modulator or an electro-absorption modulator (EAM).

9. The optical transmitter according to claim 1, wherein each of the optical intensity modulators receives a binary electrical signal whose amplitude is modulated, and modulates a corresponding split optical signals output from the optical power splitter into a binary optical signal using the amplitude-modulated binary electrical signal.

10. The optical transmitter according to claim 9, wherein the N optical intensity modulators receive binary electrical signals whose amplitudes are modulated in a ratio of
$$1 \text{:} \frac{1}{2} \text{:} … \text{:} \frac{1}{{2}^{N - 1}} ,$$
respectively.

11. A method of generating a multi-level optical signal of an optical transmitter, comprising:
splitting one optical signal into N paths using an optical power splitter;
modulating the split optical signals output from optical power splitter into binary optical signals using N optical intensity modulators; and
combining the intensity-modulated optical signals output by the N optical intensity modulators, and generating a multi-level optical signal having 2^{N} levels using an optical power combiner.

12. The method according to claim 11, wherein the modulating the split optical signals output by the optical power splitter into the binary optical signals using the N optical intensity modulators comprises:
receiving a binary electrical signal; and
modulating the split optical signals output from the optical power splitter into binary optical signals using the binary electrical signals.

13. The method according to claim 11, wherein the optical intensity modulator is a Mach-Zehnder optical intensity modulator or an electro-absorption modulator (EAM).

14. The method according to claim 11, wherein the optical power splitter and the optical power combiner have a splitting ratio and a combining ratio, respectively, so that the intensity-modulated optical signals are output in a ratio of 2^{N-1}: . . . :2¹:1 at an output port of the optical power combiner.

15. The method according to claim 11, wherein a splitting ratio of the optical power splitter and a combining ratio of the optical power combiner are both 1: . . . :1:1, and the method further comprises attenuating the optical power at a corresponding path using an optical attenuator located in front of or behind the power intensity modulator.

16. The method according to claim 15, further comprising:
adjusting the intensity of each of the optical signals combined by the optical power combiner using a monitoring photodiode.

17. The method according to claim 11, further comprising:
receiving a binary electrical signal whose amplitude is modulated;
modulating each of the split optical signals output by the optical power splitter into a binary optical signal using the amplitude-modulated binary electrical signal.
